(19) United States
(12) Patent Application Publication
(10) Pub. No.: US 2006/0277782 A1
(43) Pub. Date: Dec. 14, 2006

(54) Negative pressure type drying machine that utilizes the energy of the sun

(76) Inventors: Ho-Hsien Chen, Neipu (TW); Tzou-Chi Huang, Neipu (TW); Fu-Liang Tsai, Neipu (TW)

Correspondence Address: PRO-TECHTOR INTERNATIONAL SERVICES, 20775 NORADA CT., SARATOGA, CA, 95070, US

(21) Appl. No.: 11/258,946

(22) Filed: Oct. 25, 2005

(30) Foreign Application Priority Data
Jun. 9, 2005 (TW) 94118995

(51) Int. Cl. F26B 13/30; F26B 21/06

(52) U.S. Cl. 34/92; 34/559

(57) ABSTRACT

A negative pressure type drying machine includes a wheeled machine base carrying an drying chamber that has the peripheral walls respectively formed of high transmittance glasses, a hygrometer/thermometer for measuring the temperature and humidity in the drying chamber, an electric heater mounted in the drying chamber at the bottom for heating the air inside drying chamber, a high pressure blower for drawing air out of the drying chamber to produce a negative pressure in the drying chamber, and a control system mounted in the wheeled machine base below the drying chamber for controlling the operation of the electric heater and the high pressure blower.

### BACKGROUND OF THE INVENTION

1. Field of the Invention

The present invention relates to a drying machine for drying agri-food products and more particularly, a negative pressure type drying machine, which keeps the drying chamber in a negative pressure status and utilizes the radiation energy of the sun to dry agri-food products efficiently.

2. Description of the Related Art

Drying agricultural products is not only to lower the moisture content but also to reduce the weight and volume as well as to extend the preservation time without affecting their quality. Various commercial drying machines are known for use to dry agricultural products and other food materials. These drying machines may use solar power and/or electric heating devices to increase the temperature of the drying chamber so as to dry the material carried in the drying chamber. An air blower may be used with an electric heater in a drying machine to blow hot air through the drying chamber, thereby accelerating the drying speed. However, using solar power to dry agricultural products and/or food materials rely upon the weather condition.

U.S. Pat. No. 6,941,673 discloses a closed circuit circulation type drying machine for this purpose. This drying machine comprises a front drying chamber and a rear condensing and heating system. The peripheral walls of the drying chamber are made of high transmittance glasses. The condensing and heating system comprises evaporators, a heat reclamation chamber, an air blower, compressors, and an electric heater. The heat reclamation chamber has installed therein a condenser and one compressor. The condenser has a heat sink attached thereto. Further, the condensing and heating system is electrically connected to an auto control system that controls the operation of the air blower, the compressors and the electric heat. By means of the effect of the heat reclamation design and the radiation of the light of the sun, the drying chamber can be maintained at about 40° C.˜45° C. without switching on the electric heater. Further, a titanium dioxide-based photocatalyst paint is used for killing germs and removing bad smell while operating outdoors. Ultraviolet lamps are mounted for killing germs in indoor operating. This design of drying machine is functional; however it can be improved to reduce electric energy consumption by reducing drying time.

### SUMMARY OF THE INVENTION

The present invention has been accomplished under the circumstances in view. It is one object of the present invention to provide a negative pressure type drying machine, which utilizes the radiation energy of the sun for drying application to reduce consumption of electric energy. It is another object of the present invention to provide a negative pressure type drying machine, which keeps the drying chamber in a negative pressure status so that drying action can efficiently be achieved at a relatively lower temperature. It is still another object of the present invention to provide a negative pressure type drying machine, which utilizes a titanium dioxide-based photocatalyst paint to react with moisture contained in the air inside the drying under the effect of the radiation energy of the sun, so as to produce OH⁻ free radicals for killing germs and removing bad smell.

To achieve these and other objects of the present invention, the negative pressure type drying machine comprises a wheeled machine base, an enclosed drying chamber, which is installed in the machine base at the top and has the peripheral walls thereof respectively formed of high transmittance glasses that admits light, a hygrometer/thermometer adapted to measure temperature and humidity in the drying chamber, an electric heater mounted in the drying chamber at the bottom and adapted to provide extra heat energy inside the drying chamber, a high pressure blower mounted in the machine base and connected to the drying chamber through an air pipe and adapted to draw air out of the drying chamber and to further produce a negative pressure in the drying chamber, and a control system mounted in the machine base below the drying chamber for controlling the operation of the electric heater and the high pressure blower. Further, the drying chamber has an inside wall surface thereof coated with a layer of titanium dioxide-based photocatalyst paint.

### BRIEF DESCRIPTION OF THE DRAWINGS

FIG. 1 is a perspective view of a negative pressure type drying machine according to the present invention.

FIG. 2 is another perspective view of the negative pressure type drying machine according to the present invention when viewed from another angle.

FIG. 3 is a drying temperature and relative humility chart obtained from the drying machine of the present invention through an idle-running test.

FIG. 4 is a temperature table obtained from the negative pressure type drying machine at the third hour after start of the machine according to the present invention.

FIG. 5 is a cost analysis chart showing the drying cost per kg of a conventional hot-air drying machine and the present invention.

FIG. 6A illustrates the outer appearance of dried Sergia lucens Hansen processed through a conventional hot air drying machine.

FIG. 6B shows the bacteria count of dried Sergia lucens Hansen processed through a conventional hot air drying machine.

FIG. 7A illustrates the outer appearance dried Sergia lucens Hansen processed through a negative pressure type drying machine according to the present invention.

FIG. 7B shows the bacteria count of dried Sergia lucens Hansen processed through a negative pressure type drying machine according to the present invention.

FIG. 8A illustrates the outer appearance of dried pineapple processed through a conventional hot air drying machine and the outer appearance of dried pineapple processed through a negative pressure type drying machine according to the present invention.

FIG. 8B is a dried pineapple L,a,b comparison table.

FIG. 9A illustrates the outer appearance of dried papaya processed through a conventional hot air drying machine and the outer appearance of dried papaya processed through a negative pressure type drying machine according to the present invention.

FIG. 9B is a dried papaya L,a,b comparison table.

### DETAILED DESCRIPTION OF THE PREFERRED EMBODIMENT

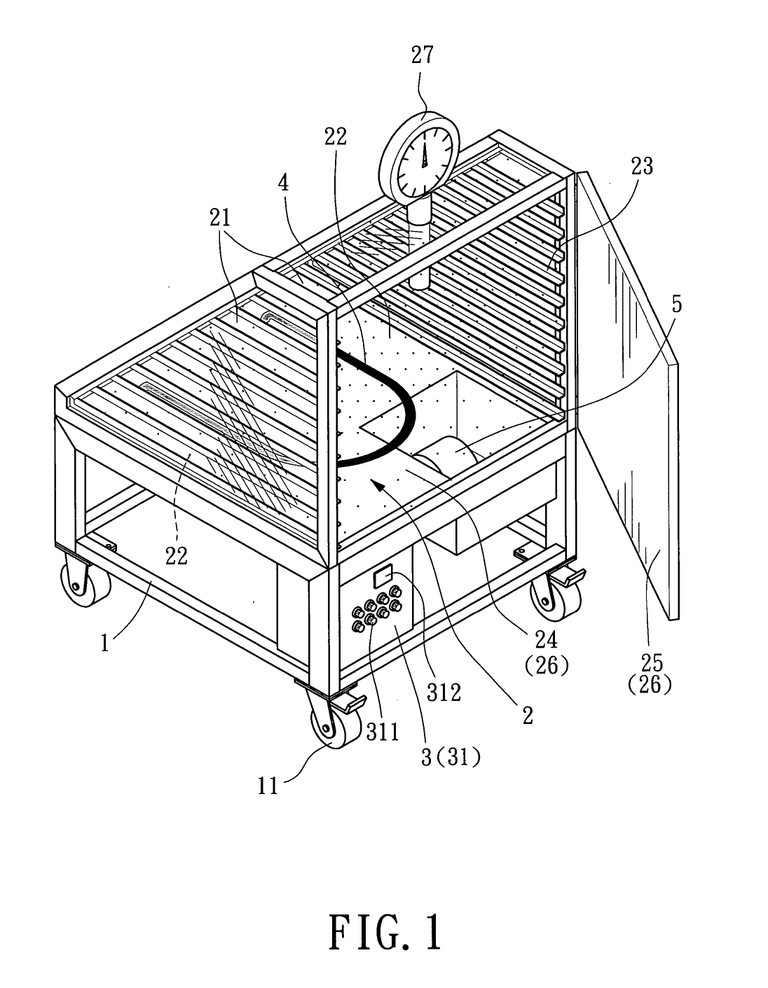

Referring to FIG. 1, a drying machine in accordance with the present invention is shown comprising a machine base 1, a drying chamber 2 provided in the machine base 1 at the top side, and a control system 3 provided in the machine base 1 at the bottom side.

The machine base 1 is equipped with wheels 11 so that the drying machine can conveniently be moved on the floor.

The drying chamber 2 is an enclosed chamber defined in the machine base 1 at the top side, having the front, top, left and right sidewalls respectively formed of a respective high transmittance glasses 21 for enabling the radiation energy of the sun to be used to dry foods or the like in the drying chamber, a photocatalyst paint 22 covered on the inner surface of each high transmittance glasses 21, a plurality of racks 23 provided at two opposite sides for supporting carrier plates (not shown) to hold foods for drying, two reflecting steel plates 26 respectively covered on the inner surfaces of the bottom wall 24 and back wall 25 of the drying chamber 2, an electric heater 4 provided at the bottom side of the drying chamber 2, a hygrometer/thermometer 27 adapted to detect temperature and humidity in the drying chamber 2, and a drain valve (not shown) in the bottom side. The back wall 25 according to this embodiment is formed of a door panel hinged to the backside of one lateral sidewall of the drying chamber 2 for drying chamber access control.

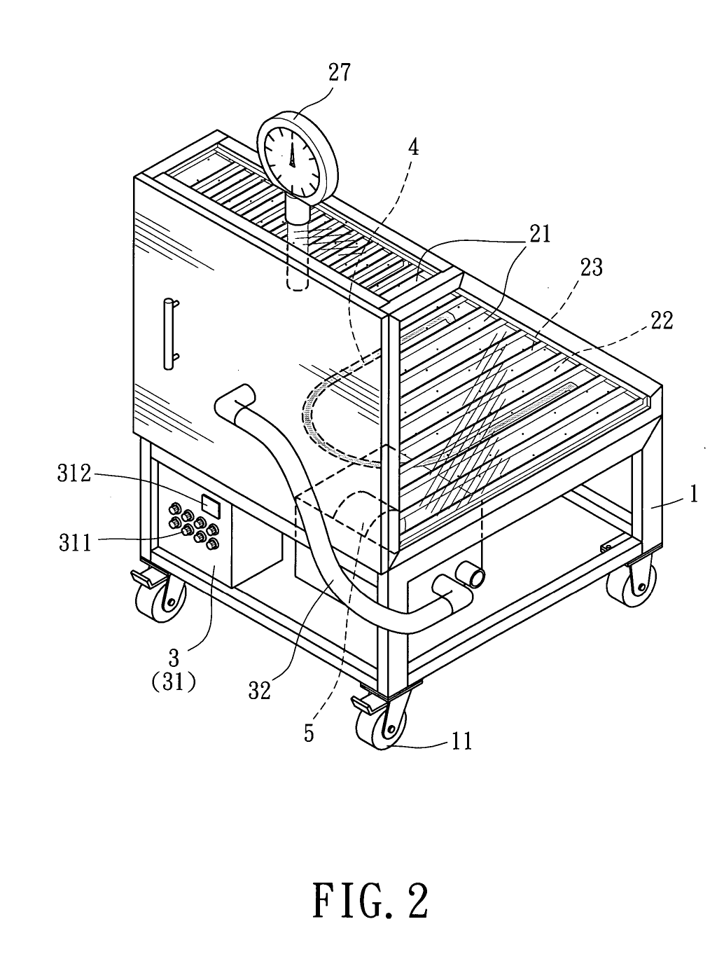

Further, a high pressure blower 5 is mounted in the machine base 1 near the bottom side and connected to the drying chamber 2 through an air pipe 32 and adapted to draw air out of the drying chamber 2 to produce a negative air pressure in the drying chamber 2 (see FIG. 2). The control system 3 is installed inside the machine base 1 below the drying chamber 2, comprising a control panel 31 electrically connected to the electric heater 4 and the high pressure blower 5 for controlling the operation of the electric heater 4 and the high pressure blower 5. The control panel 31 comprises a plurality of control buttons 311 adapted to control on/off of the electric heater 4 and the high pressure blower 5, and a temperature display 312.

When in use outdoors, the user controls on/off of the electric heater 4 and the high pressure blower 5 based on a weather condition. When started the high pressure blower 5, a negative pressure is produced in the drying chamber 2, causing the materials that absorb the radiating energy of the sun to reach the expected drying temperature quickly. Because the high transmittance glasses 21 admit light and the reflecting steel plates 26 reflect the light of the sun toward the inside of the drying chamber 2, the radiation energy of the sun is fully utilized. Further, the high pressure blower 5 saves much electric energy when compared to regular vacuum pumps. Therefore, the drying chamber 2 can reach the expected drying temperature quickly with a short period operation of the electric heater 4 or may be totally without the operation of the electric heater 4. Further, the photocatalyst paint 22 is activated by the radiation energy of the sun to kill germs in the drying chamber 2 and removing bad smell from the drying chamber 2. Further, the high pressure blower 5 can obtain the necessary working voltage from city power supply. Alternatively, a storage battery may be used with a photovoltaic cells system to provide the necessary working voltage to the high pressure blower 5.

The utility and inventive steps of the present invention are proved in various tests as outlined hereinafter.

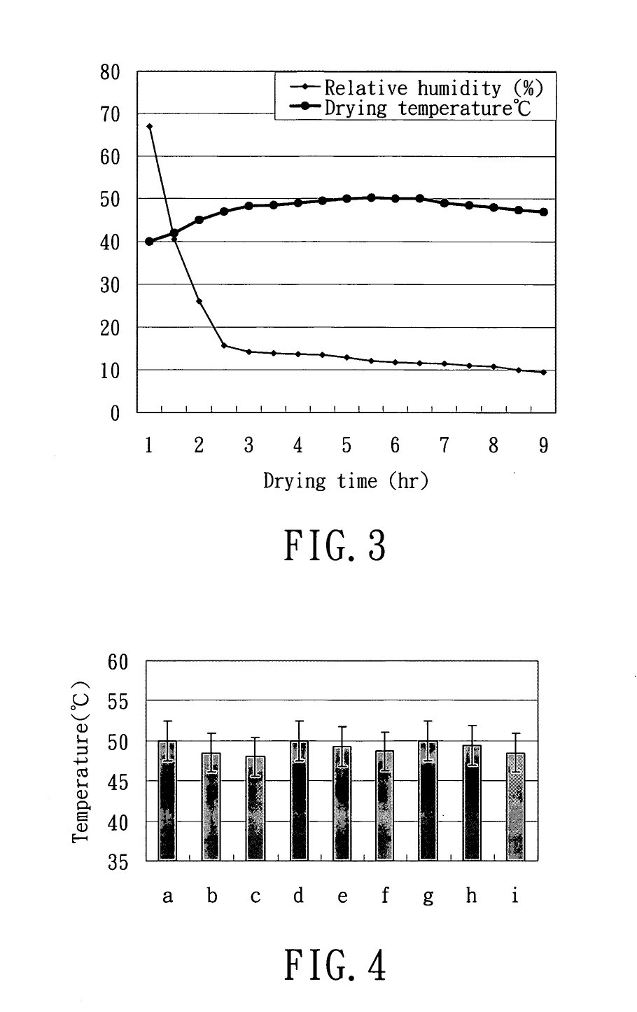

FIG. 3 is a drying temperature and relative humility chart obtained from the drying machine of the present invention through an idle-running test. After 3.5 hours running of the drying machine, the temperature in the drying chamber is maintained within 45˜50° C.

FIG. 4 is a temperature table obtained from the solar power-operated negative pressure type drying machine at 3 hours after started of the machine according to the present invention. This test measured the temperature of the drying chamber of the drying machine at 9 different locations at the third hour after start of the drying machine. As indicated, the lowest temperature value, at location f, measured is 48.3° C., the highest temperature value, at location d, measured is 50.2° C., and the temperature variation range is about within 1° C. Therefore, the invention enables the materials to be evenly and quickly heated to the expected dry status.

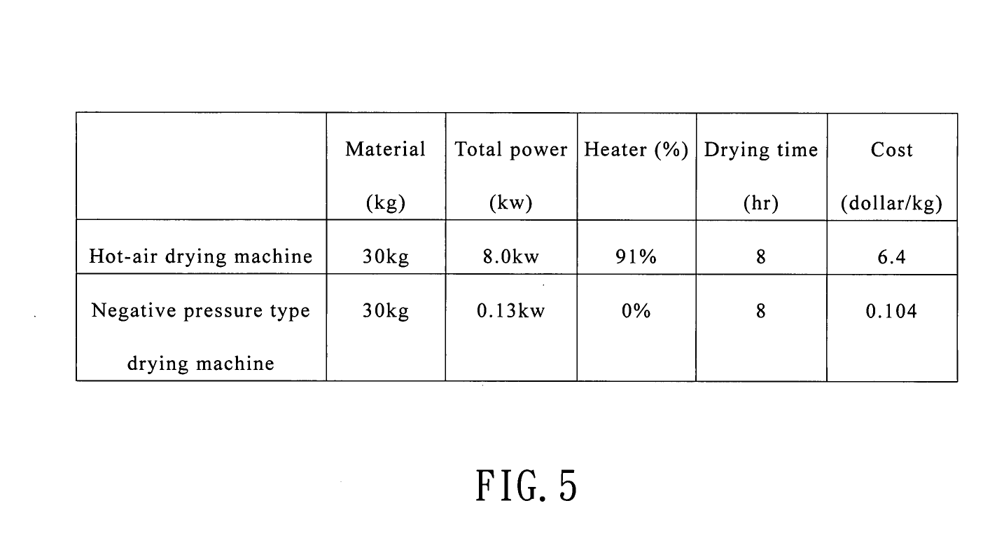

FIG. 5 is a cost analysis chart showing the drying cost per kg of a conventional hot air drying machine and the present invention. As indicated, the invention consumes less energy and the processing cost of the present invention is much lower when compared to the conventional hot air drying machine.

Referring to FIG. 1 again, the drying chamber 2 is the main part of the present invention. It absorbs the radiation energy of the sun and holds the materials for drying. Because the peripheral walls of the drying chamber 2 are formed of high transmittance glasses 21 that admit light. The radiation energy of the sun can directly pass through the high transmittance glasses 21 into the inside of the drying chamber 2 to dry the agricultural products and/or other food materials carried in the drying chamber 2. By means of this drying process, the taste of the agricultural products and/or food materials is maintained. Under the radiation of the ultraviolet rays of the light of the sun, the vitamin D content of the drying materials such as Lentinus edodes is increased. Further, because the inside wall surface of the drying chamber 2 is coated with a layer of titanium dioxide-based photocatalyst paint, moisture contained in the air inside the drying chamber can be triggered to produce OH⁻ free radicals and negative oxygen ions that kill germs and remove bad smell. Further, repeated tests of the present invention exhibits bacteria count reduction to 2-3CFU, or even to zero reading.

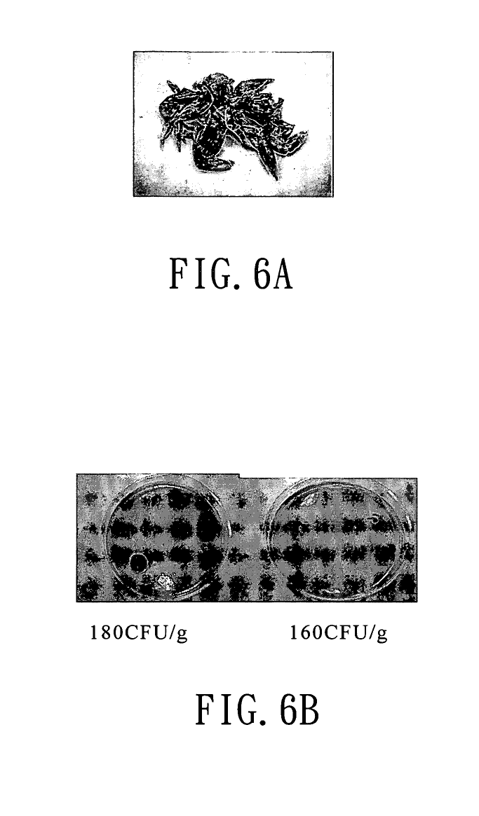

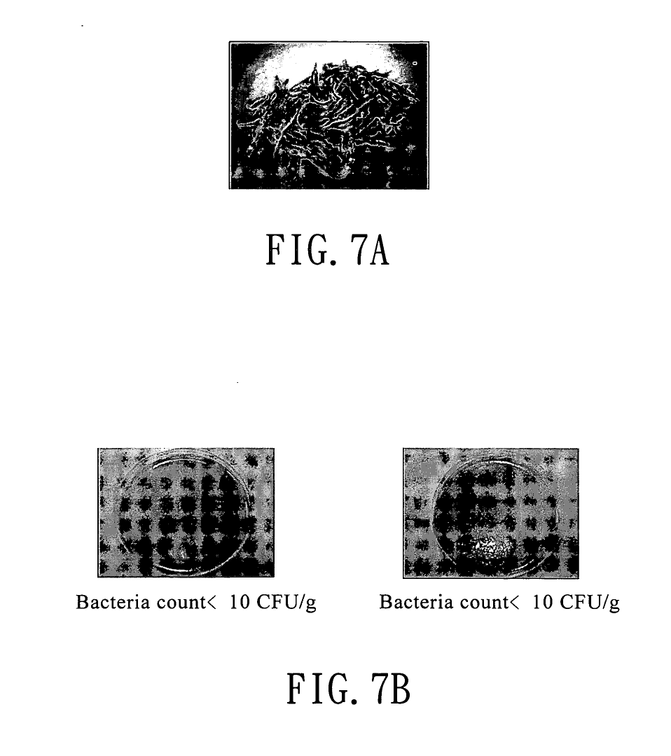

FIG. 6A illustrates the outer appearance of dried Sergia lucens Hansen processed through a conventional hot air drying machine. FIG. 6B shows the bacteria count of the dried Sergia lucens Hansen shown in FIG. 6A. FIG. 7A illustrates the outer appearance dried Sergia lucens Hansen processed through the negative pressure type drying machine of the present invention. FIG. 7B shows the bacteria count of the dried Sergia lucens Hansen processed shown in FIG. 7A. As indicated, the dried Sergia lucens Hansen processed through the conventional hot air drying machine has a relatively darker color and a relatively higher bacteria count.

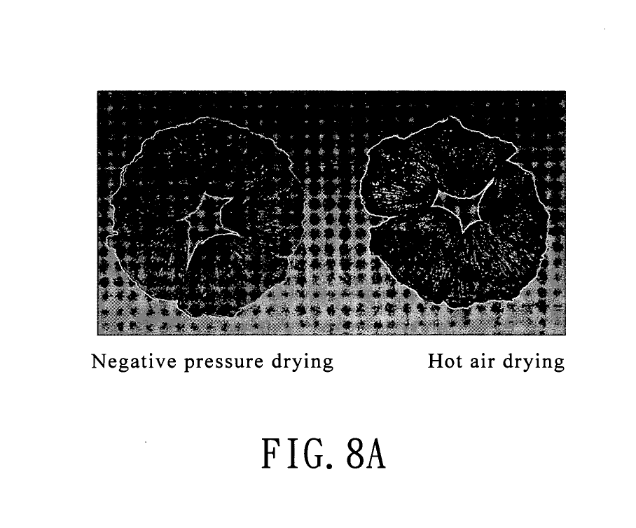

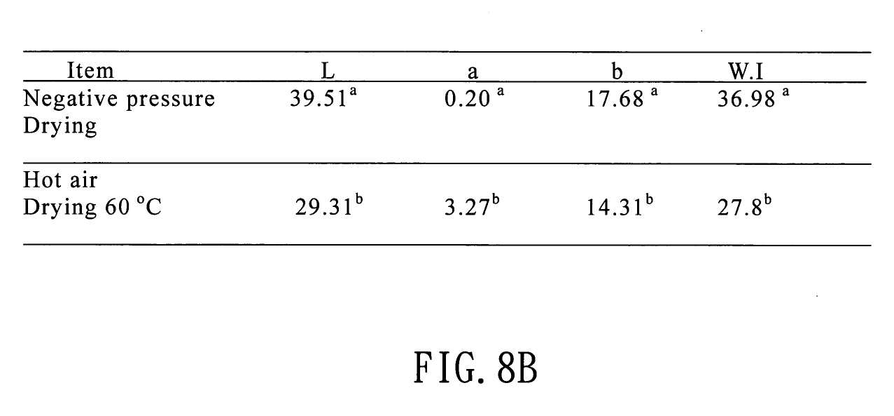

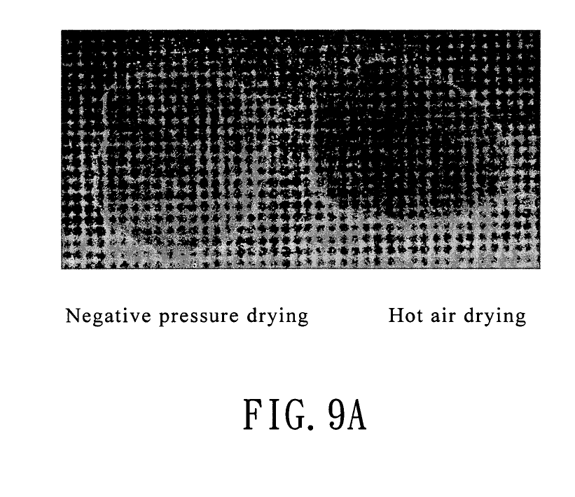

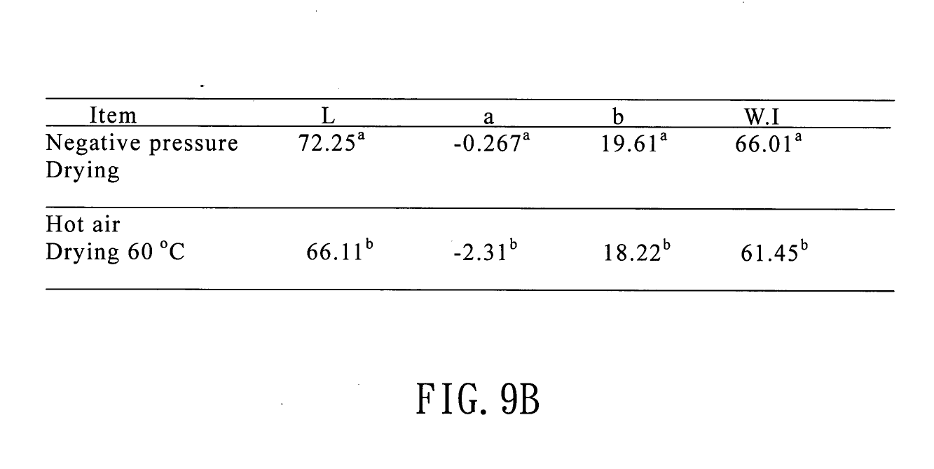

FIG. 8A illustrates the outer appearance of dried pineapple processed through a conventional hot air drying machine and the outer appearance of dried pineapple processed through a negative pressure type drying machine according to the present invention. FIG. 8B is a dried pineapple L,a,b comparison table. FIG. 9A illustrates the outer appearance of dried papaya processed through a conventional hot air drying machine and the outer appearance of dried papaya processed through a negative pressure type drying machine according to the present invention. FIG. 9B is a dried papaya L,a,b comparison table. As indicated, dried products processed through the conventional hot air drying machine has a relatively lower L value that means a relatively darker color. When analyzed through SAS analysis, significant differences are shown between the dried products processed through the conventional hot air drying machine and the negative pressure type drying machine of the present invention. The dried products processed through the negative pressure type drying machine shows a relatively brighter color and a relatively higher WI (White Index) value.

Further, the reflective steel plates 26 at the bottom and back sides inside the drying chamber 2 reflect the light of the sun, enhancing the radiation energy of the sun for drying the materials efficiently, and there the radiation energy of the sun is fully utilized. Further, the rollers 11 allow the drying machine to be conveniently moved to different directions subject to the change of the radiation angle of the sun.

As indicated above, the invention provides a negative pressure type drying machine, which fully utilizes the radiation energy of the sun for drying agricultural products and food materials while maintaining the drying chamber in a negative pressure status. The drying machine also utilizes a titanium dioxide-based photocatalyst paint to trigger moisture under the presence of the radiation energy of the sun, causing moisture to decompose and to further produce OH⁻ free radicals and negative oxygen ions that kill germs and remove bad smell. Using the drying machine of the present invention to dry agricultural products and food materials can maintain the good quality of the materials and prohibit the effect of enzyme. Therefore, dried materials processed through the drying machine of the present invention can be kept for long.

A prototype of negative pressure type drying machine has been constructed with the features of FIGS. 1 and 2. The negative pressure type functions smoothly to provide all of the features discussed earlier.

Although a particular embodiment of the invention has been described in detail for purposes of illustration, various modifications and enhancements may be made without departing from the spirit and scope of the invention.

What the invention claimed is:

1. A negative pressure type drying machine comprising:
a machine base;
an enclosed drying chamber installed in a top side of said machine base, said drying chamber having a plurality of peripheral walls respectively formed of high transmittance glasses;
a hygrometer/thermometer adapted to detect temperature and humidity in said drying chamber;
an electric heater mounted in a bottom side of said drying chamber and adapted to heat the air inside said drying chamber; and
a control system mounted in said machine base at a bottom side below said enclosed drying chamber, said control system comprising a control panel and adapted to control the operation of said electric heater;
wherein a high pressure blower is electrically connected to said control panel and adapted to draw air out of said enclosed drying chamber to further produce a negative pressure in said enclosed drying chamber, said high pressure blower having an air input port connected to the inside of said enclosed drying chamber through an air; said control panel comprises a plurality of control buttons respectively electrically connected to said electric heater and said high pressure blower to control on/off of said electric heater and said high pressure blower.

2. The negative pressure type drying machine as claimed in claim 1, wherein said machine base has a plurality of rollers pivotally provided at a bottom sides thereof for moving.

3. The negative pressure type drying machine as claimed in claim 1, wherein said drying chamber has an inside wall surface thereof coated with a layer of photocatalyst paint.

4. The negative pressure type drying machine as claimed in claim 1, wherein said drying chamber has reflecting steel plates provided at an inner side of bottom and back walls thereof.

5. The negative pressure type drying machine as claimed in claim 1, wherein said high pressure blower is mounted in said machine base at a bottom side of said enclosed drying chamber.
